(19) United States
(12) Patent Application Publication
(10) Pub. No.: US 2024/0214725 A1
(43) Pub. Date: Jun. 27, 2024

(54) APPARATUSES, SYSTEMS, AND METHODS FOR DETECTING SOUND VIA A WEARABLE DEVICE

(71) Applicant: Meta Platforms Technologies, LLC, Menlo Park, CA (US)

(72) Inventors: Chuming Zhao, Bellevue, WA (US); Andrew Chen, Culver City, CA (US); Ninus Brodin, Stockholm (SE); Igor Markovsky, Campbell, CA (US); Kirk Erik Burgess, Newark, CA (US); Peter Mikael Mogren, Seattle, WA (US); Rick Yuan Chao, Plano, TX (US)

(21) Appl. No.: 18/393,249

(22) Filed: Dec. 21, 2023

Related U.S. Application Data
(60) Provisional application No. 63/476,667, filed on Dec. 22, 2022.

(51) Int. Cl. H04R 1/46

(52) U.S. Cl. CPC H04R 1/46; H04R 2201/023

(57) ABSTRACT

Apparatuses, systems, and methods for detecting sound via a wearable device are described herein. An example system may include a pair of glasses that include a nose pad that, when the pair of glasses are worn by a user, contacts a portion of a nose of the user at a contact point and a vibration sensor, included in the nose pad. The vibration sensor may be configured to receive vibrations produced by the user via the contact point, and convert the received vibrations into an electrical signal representative of the received vibrations. The system may also include a control device configured to receive the electrical signal, and convert the electrical signal into digital audio data. Various other apparatuses, systems, and methods are described herein.

### CROSS-REFERENCE TO RELATED APPLICATION

This application claims the benefit of U.S. Provisional Patent Application No. 63/476,667, filed Dec. 22, 2022, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a simplified cross-section view of an apparatus for detecting sound via a wearable device.

FIG. 2 is a cross-sectional view illustrating an example apparatus for detecting sound via a nose pad included in a pair of glasses, consistent with the apparatuses, systems, and methods presented herein.

FIG. 3 presents a detailed cross-sectional view of an example embodiment of an apparatus for detecting sound via a nose pad incorporated into a pair of glasses.

FIG. 4 provides a close-up perspective view that shows a contact microphone assembly within the context of a wearable device—specifically, a pair of glasses.

FIG. 5 presents a perspective view that illustrates an embodiment where a contact microphone assembly is incorporated into the nose pad area of a pair of glasses.

FIG. 6 provides a cross-sectional view that illustrates a potential integration of a contact microphone assembly within the framework of a wearable device, which in this case is exemplified as a pair of smart glasses.

FIG. 7 sets forth an illustrative example of how various components, including a flexible membrane, might be configured within the framework of smart glasses to enhance audio capture capabilities.

FIG. 8 presents a detailed cross-sectional view of an example of an apparatus for detecting sound through a nose pad integrated into a pair of glasses.

FIG. 9 presents a close-up perspective view, which emphasizes a specific aspect of the integration of a contact microphone assembly within the structure of a wearable device, such as a pair of glasses.

FIG. 10 shows an alternative perspective view of a contact microphone assembly integrated within a nose pad of a pair of smart glasses.

FIG. 11 is a block diagram of an example system for detecting sound via a wearable device.

FIG. 12 is a block diagram of an example implementation of a system for detecting sound via a wearable device.

FIG. 13 is a flow diagram of an example computer-implemented method 1300 for detecting sound via a wearable device.

FIG. 14 and FIG. 15 include charts that illustrate some of the benefits of the apparatuses, systems, and methods disclosed herein.

FIG. 16 is an illustration of example augmented-reality glasses that may be used in connection with embodiments of this disclosure.

FIG. 17 is an illustration of an example virtual-reality headset that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Modern wearable technologies, including head- or eye-worn wearable computers commonly referred to as “smart glasses,” are evolving to enhance user interaction with information and other users in various ways. These audio-forward devices are designed to facilitate a range of voice-related use cases, such as voice communication with other users, voice interaction with the wearable device, video recording, and live streaming. Many of these applications require or greatly benefit from a high signal-to-noise ratio (SNR) in the audio input signal for optimal performance.

However, current wearable technologies face several challenges that impact their performance, particularly in terms of achieving a sufficient audio input SNR, especially in challenging conditions. Key among these challenges are environmental factors like wind noise and ambient background noise, as well as interference from non-user speech. These variables significantly hinder the device's ability to effectively capture and process audio inputs, leading to degraded audio quality and reduced accuracy in voice command detection and voice communication.

In light of these limitations, there is a recognized need for improved audio input technologies in wearable devices such as smart glasses. The current disclosure aims to address this need by introducing an innovative approach to audio input that enhances the performance of wearable devices in various challenging audio environments. This approach involves the use of contact microphone technology, specifically designed and integrated into wearable devices like smart glasses, to capture audio signals more effectively. By focusing on improving the audio input capabilities, this solution aims to overcome the prevalent issues of environmental noise interference and to elevate the overall user experience with wearable devices.

More specifically, the present disclosure is directed to apparatuses, systems, and methods for detecting sound via a nose pad included in a pair of glasses. In an example embodiment, a nose pad in a pair of glasses may include a vibration sensor such as a contact microphone. When the user wears the pair of glasses, the nose pad may physically contact the nose of the user at a certain point (e.g., a contact point). When the user speaks, bones in the user's face may vibrate in accordance with the sound of the user's speech. The vibration sensor may detect the vibrations of the user's facial bones (e.g., via bone conduction) and may transduce the vibrations into an electrical signal. In some embodiments, a control device may receive the electrical signal and may transform the electrical signal into audio data. In some examples, the control device may further process the audio data to adjust one or more aspects of the audio data, such as to improve intelligibility of user speech represented by the audio data.

Embodiments of the apparatuses, systems, and methods described herein may provide improved user experiences by reducing wind noise and/or ambient noise in an audio signal, rejecting sound produced by other speakers, and enabling alternative modes of use not available through conventional solutions such as ultra-low power modes, or whispering instead of speaking at a regular or higher volume.

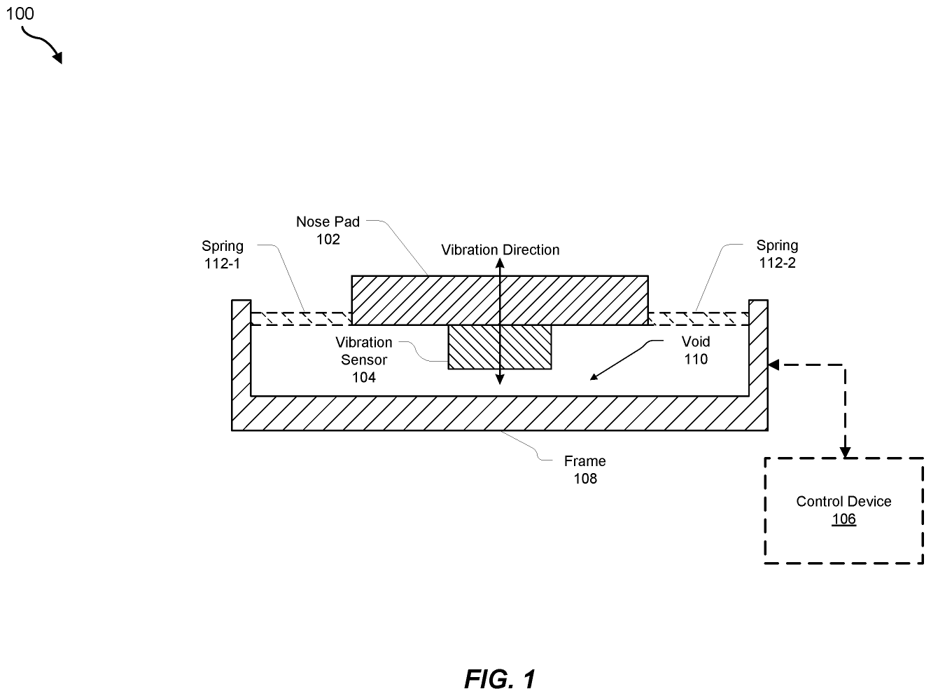

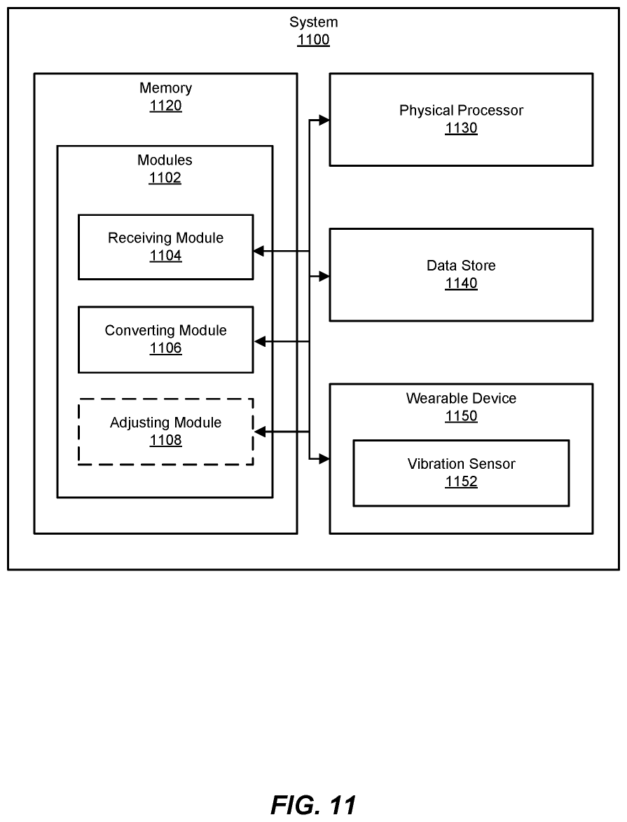

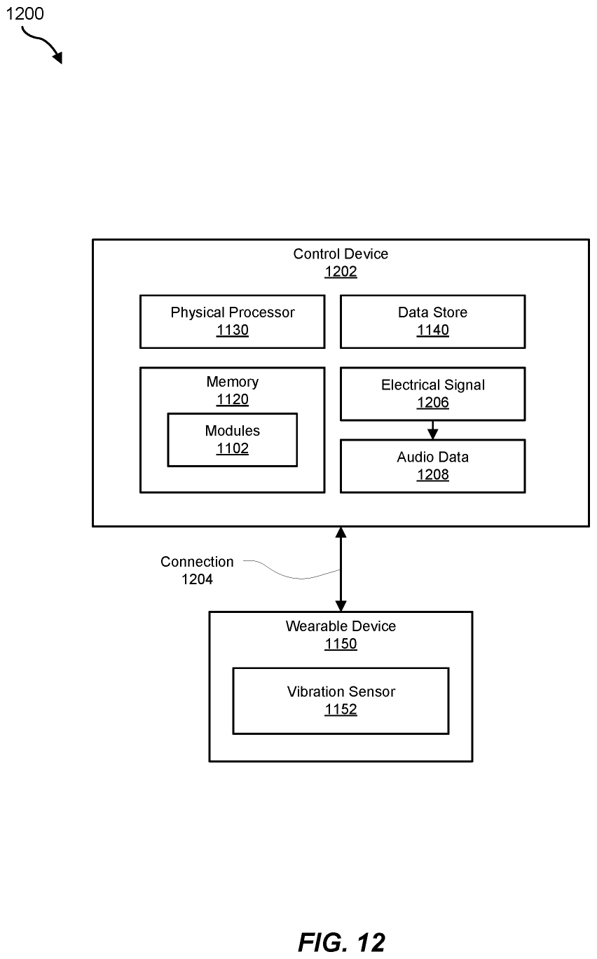

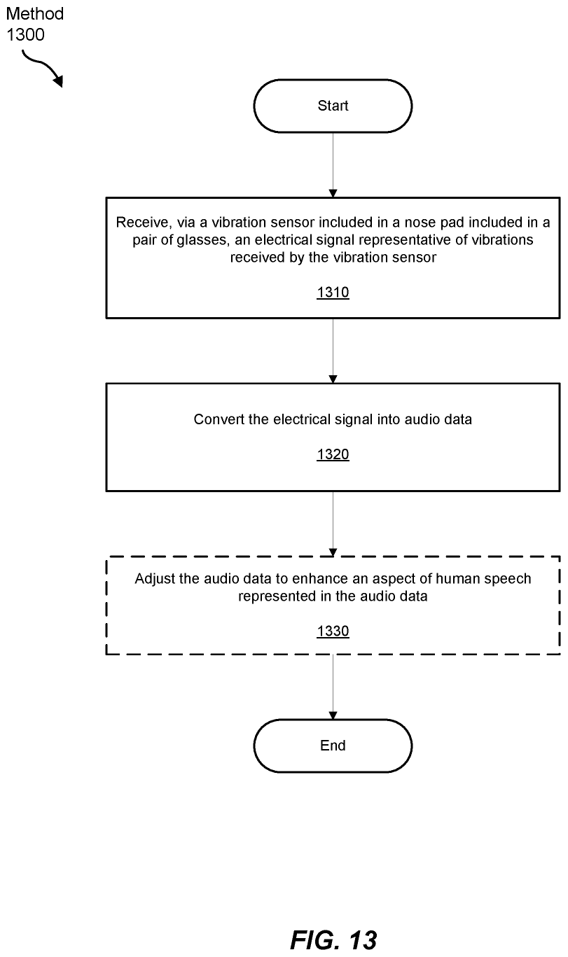

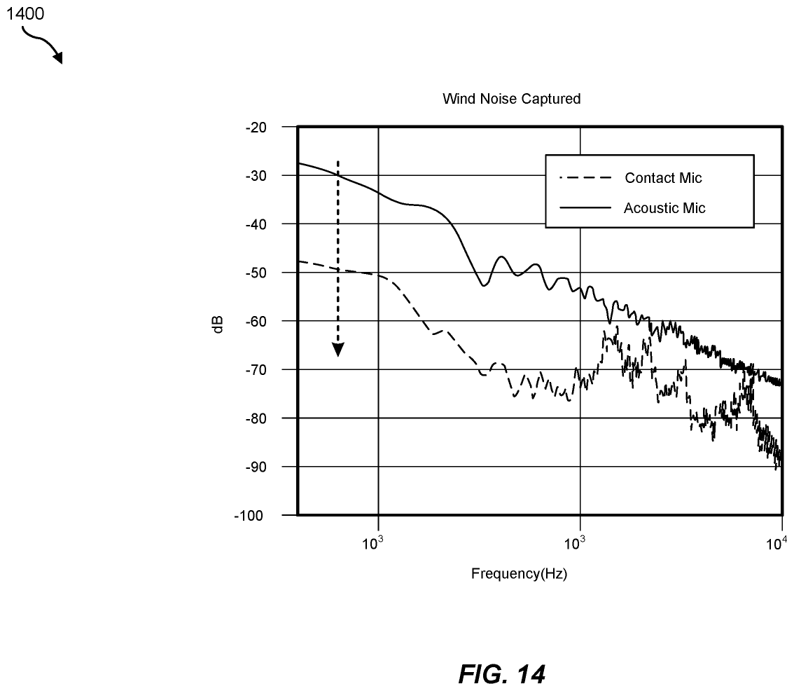

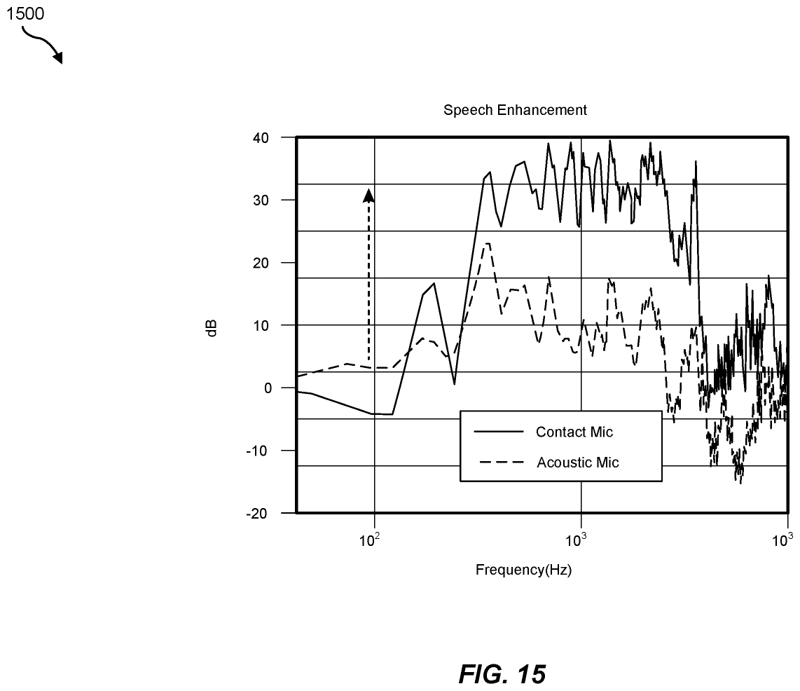

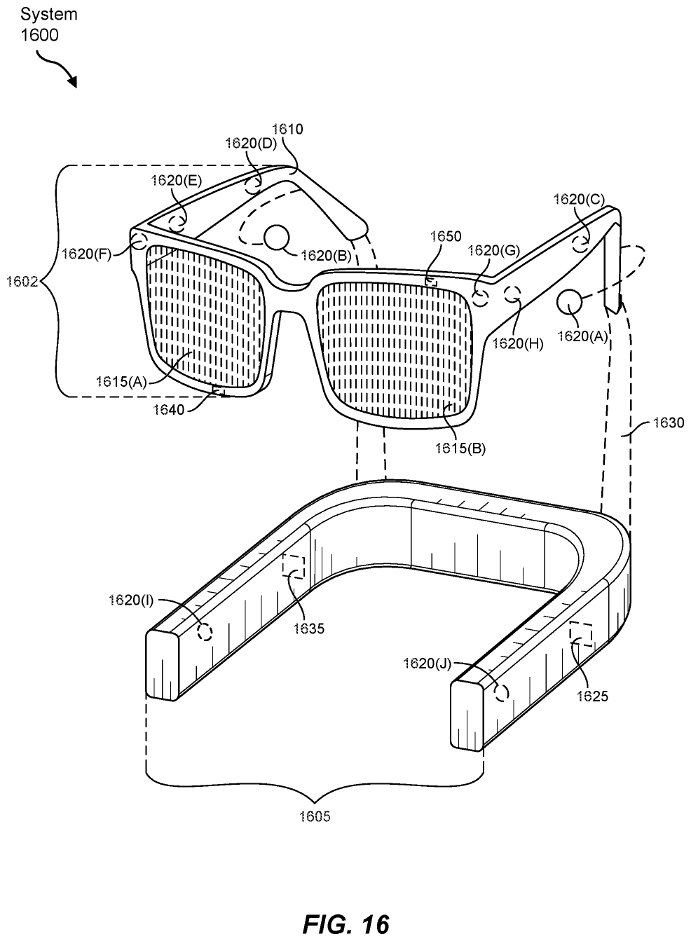

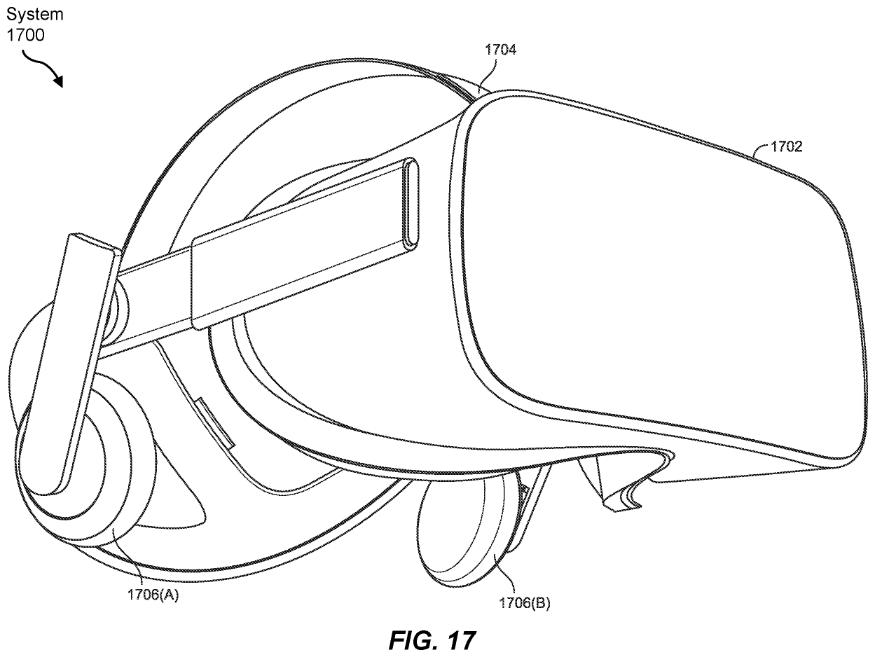

The following will describe, in reference to FIGS. 1-10, various examples and illustrations of apparatuses for detecting sound via a nose pad included in a pair of glasses. Furthermore, various examples and illustrations of systems for detecting sound via a nose pad included in a pair of glasses will be described below in reference to FIGS. 11-12. Various methods of detecting sound via a nose pad included in a pair of glasses will be described below in reference to FIG. 13. Data indicating some benefits offered by the apparatuses, systems, and methods described herein will be described below in reference to FIGS. 14-15. Finally, various artificial reality systems that may incorporate elements of the apparatuses, systems, and methods described herein will be described below in reference to FIGS. 16-17.

FIG. 1 illustrates an example apparatus 100 as detailed in the present disclosure. This depiction is a simplified cross-section, with elements shown in dashed lines indicating optional components that may not be included in all embodiments.

The apparatus features a pad 102 positioned within a void 110 in a frame 108. This void is specifically dimensioned to not only accommodate the pad but also permit its movement in response to vibrations received, which may be generated by the user's speech via bone conduction. Movement of the pad 102 is supported and guided by spring 112-1 and/or spring 112-2, allowing for controlled displacement in the indicated “Vibration Direction”. The springs may be made from materials that optimize the transmission of vibrations to the vibration sensor, such as polymers or metals, and could consist of multiple elements that connect the frame to the pad at various points.

Moreover, the pad 102 may incorporate a rigid contact member, not explicitly shown in FIG. 1, which maintains contact, via a contact point, with the user's body, such as the user's nose, conforming to general dimensions and contours of the user's body. The rigid contact member may facilitate direct transfer of vibrations from the user's body to the vibration sensor 104, which may be in physical contact with or mounted to the rigid contact member. The sensor is capable of converting these vibrations into an electrical signal indicative of the received audio data through bone conduction. The frame 108 encases the assembly, providing structural stability and defining the environment for the nose pad's movement and the sensor's operation.

A control device 106 is shown in a dashed outline, indicating its role in processing the electrical signal into audio data and its variable placement within the overall design of the glasses. As will be described in greater detail below in reference to FIG. SS The control device represents a computing system capable of executing instructions, minimally including a memory device and a physical processor. In some examples, control device 106 may include one or more modules configured to perform one or more tasks when executed by the physical processor. In some embodiments, the one or more modules may, when executed by the physical processor, receive the electrical signal and convert the electrical signal into digital audio data. In additional embodiments, the one or more modules may, when executed by the physical processor, adjust the audio data to enhance an aspect of human speech represented in the audio data. For example, the control device may employ one or more equalization algorithms to correct and/or enhance bone conducted speech to sound more natural.

Additionally or alternatively, the one or more modules may employ one or more algorithms (e.g., audio digital signal processing, artificial intelligence, machine learning, and/or other algorithms) to further reduce noise in and/or correct received bone-conduced speech to further improve an audio signal (e.g., increase the SNR, or make bone conducted signal more sounds more natural). In some examples, the one or more modules may adjust the audio data to enhance clarity of and/or isolate human speech produced by the user as opposed to human speech produced by another person (e.g., another person speaking in close proximity to the user).

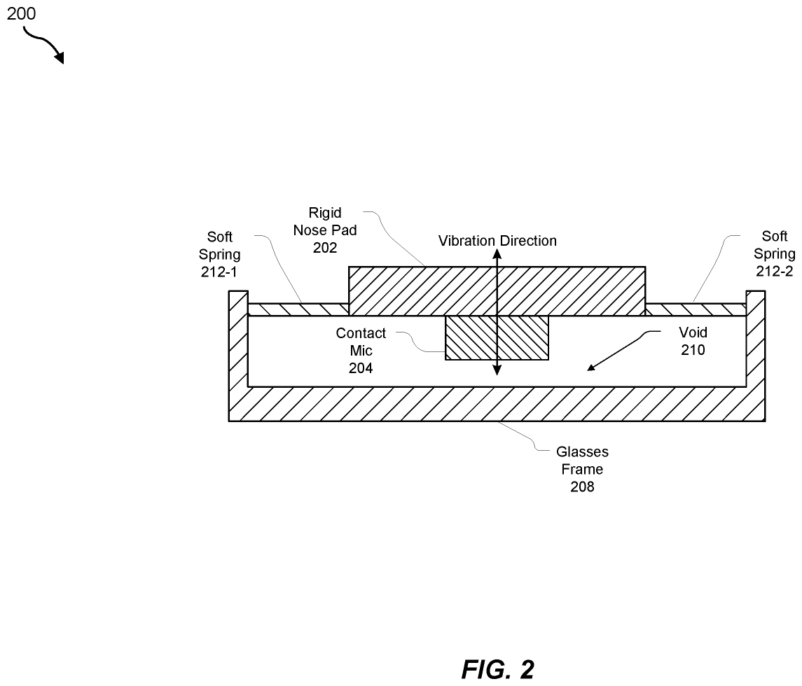

FIG. 2 is a cross-sectional view 200 illustrating an example apparatus for detecting sound via a nose pad included in a pair of glasses, consistent with the apparatuses, systems, and methods presented herein. Although similar to FIG. 1, FIG. 2 shows integration of components within a glasses structure for the purpose of capturing audio through bone conduction.

As shown, rigid nose pad 202 is configured to make contact with the user's nose at a specific contact point when the glasses are worn. The rigidity of the nose pad 202 ensures consistent contact with the user's nose to facilitate the direct transmission of vibrations resulting from speech.

The rigid nose pad 202 is positioned within a defined void 210 in the glasses frame 208. This void 210 is dimensioned to both house the nose pad 202 and permit a degree of movement, which is essential for the effective transmission of vibrations from the user to the sensor.

On either side of the nose pad 202, soft spring 212-1 and soft spring 212-2 are implemented to provide flexible support. These soft springs allow the nose pad 202 to move along the axis indicated by the “Vibration Direction,” which corresponds to the typical path of vibrations as they are conducted from the user's nose through bone conduction.

Located below the nose pad 202 is a contact microphone sensor 204, which is detecting the vibrations that are produced by the user. The contact microphone 204 is in an advantageous position to capture vibrations transmitted through the rigid nose pad 202 and convert them into an electrical signal that can be further processed into audio data.

In some examples, a contact microphone may include or represent a type of microphone that captures audio by sensing vibrations through solid materials. Unlike conventional acoustic microphones that may pick up sound through air vibrations, a contact microphone may detect physical vibrations that pass through objects.

A contact microphone may include an active element that generates an electrical signal when it is subjected to mechanical stress or vibrations. When attached to a resonant object, the active element may convert vibrations from the object into electrical signals, which can then be amplified and converted into audible sound. In some examples, the active element may piezoelectric and/or capacitive.

Contact microphones may be particularly useful in situations where air-borne sound capture is difficult or ineffective. For example, they are used in electronic music to amplify sounds from unconventional instruments or objects, in sound design for capturing unique textures, and in various industrial and scientific applications where capturing vibrations directly from a surface is necessary. Due to their method of operation, contact microphones have a different response to sound compared to traditional air microphones, often resulting in a more raw or textured audio output.

In some examples, some contact microphones described herein may further include an integrated stack-up assembly, which may enable efficient sound conversion. An integrated stack-up assembly may include a sensing element, either capacitive or piezoelectric and based on micro-electro-mechanical systems (MEMS) technology, designed to convert mechanical vibrations into electrical signals. This element may be mounted on a substrate that provides mechanical support and facilitates electrical signal transfer.

A protective layer may encase the sensor and substrate, shielding them from environmental factors like dust and moisture. The assembly may also include signal conditioning components, such as resistors and capacitors, which may refine the sensor's raw signal by filtering noise and amplifying relevant vibrations.

Interface materials, selected for their acoustic properties, aid in transmitting sound to the sensor. The entire assembly is housed within a casing that ensures the components' stability and alignment. This structure enables the contact microphone to capture sound with precision, making it suitable for applications in wearable technology.

The glasses frame 208 encapsulates the aforementioned components (e.g., nose pad 202, contact microphone 204, soft springs 212, etc.) providing a durable and stable structure that maintains the relative positions of the components to ensure the functionality of the apparatus.

This figure demonstrates a practical implementation of the components in a manner that facilitates the reception of user-generated vibrations, while also potentially offering a comfortable and secure fit for the user.

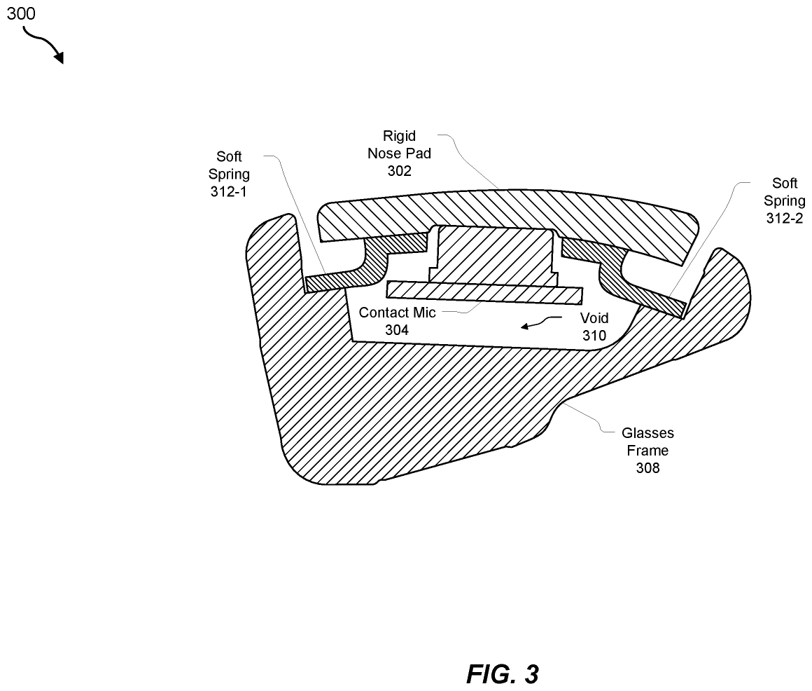

FIG. 3 presents a detailed cross-sectional view 300 of an example embodiment of an apparatus for detecting sound via a nose pad incorporated into a pair of glasses. This embodiment aligns with the inventive concepts and is configured to optimize audio capture via bone conduction.

A rigid nose pad 302 is positioned to interface with the user's nose when the glasses are worn. The design of the rigid nose pad 302 ensures stable and direct contact with the skin, facilitating the transmission of sound vibrations from speech or other vocalizations by the user.

The rigid nose pad 302 is accommodated within a void 310 that is defined by the glasses frame 308. The void 310 is dimensioned to not only accommodate the rigid nose pad 302 but also to allow for its necessary movement in the indicated “Vibration Direction.” This movement is integral to maintaining the fidelity of the audio signal captured from the user's speech through the vibrations conducted by the facial bones.

On either side of the rigid nose pad 302, soft springs 312-1 and 312-2 are configured to provide a balance between support and flexibility, facilitating the movement of the rigid nose pad 302 in response to vibrations received from a user, thereby ensuring consistent contact and transmission of sound vibrations.

Positioned directly beneath the rigid nose pad 302 is a contact microphone 304, placed to effectively receive bone-conducted vibrations. The sensor is responsible for transducing these mechanical vibrations into electrical signals, thus representing the audio data for further processing.

The glasses frame 308 encases the assembly, providing robust support and ensuring the structural integration of the components. The frame 308 is designed in conjunction with void 310 and soft springs 312-1 and 312-2 to facilitate the apparatus's sound detection functionality.

FIG. 3 therefore illustrates a synergistic arrangement of mechanical components within a wearable device, enhancing the clarity and accuracy of audio detection via bone conduction and demonstrating the potential for an ergonomic and efficient design suited for extended use by the wearer. In some examples, the apparatus depicted in this figure may be referred to as a “contact microphone assembly.”

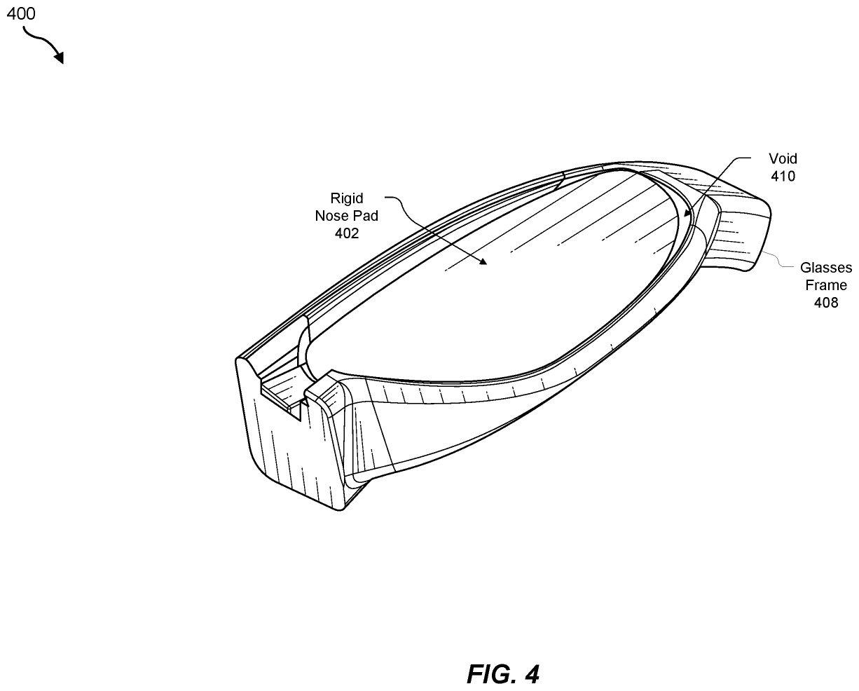

FIG. 4 provides a close-up perspective view 400 that shows a contact microphone assembly within the context of a wearable device—specifically, a pair of glasses. This view emphasizes the integration and positioning of the sound-detection components in relation to the user's nose when the user wears the glasses.

As depicted, the rigid nose pad 402 is engineered with user comfort in mind, shaped to conform to the contours of a user's nose. Its dimensions ensure that when the user dons the glasses, the nose pad 402 makes a comfortable yet secure contact, which may enable effective transmission of user-generated bone-conducted sound vibrations during speech or other vocal activities.

Surrounding the rigid nose pad 402 in this view is a void 410. This void 410 is defined, sized, and/or configured to align with the shape and size of the nose pad 402, allowing for a certain degree of movement and positioning flexibility. Such accommodation is crucial for the dynamic nature of the nose pad 402 as it responds to the subtle shifts and vibrations that occur during use, as well as to provide a degree of cushioning of the weight of the glasses as they interact with the user's nose.

The glasses frame 408, illustrated in FIG. 4, is designed to provide both aesthetic appeal and functional stability. Its structure not only supports the placement of the rigid nose pad 402 but also serves to protect and conceal the contact microphone assembly (not visible in this view) that lies beneath the nose pad 402.

While the contact microphone sensor itself is not directly shown in this perspective, its location is implied to be immediately beneath the rigid nose pad 402 and within the glasses frame 408. The sensor's placement may enable capture of vibrational energy of audio conducted via bones, cartilage, and other tissues of the user's nose. The contact microphone sensor may convert the captured energy into an electrical signal representative of the captured audio.

This illustration of the contact microphone assembly in FIG. 4 indicates a careful consideration given to the design and user experience. By integrating the microphone assembly in such a manner, the invention ensures that sound detection is both efficient and unobtrusive, aligning with the sleek and minimalistic design ethos that is often desired in modern wearable technology.

Overall, FIG. 4 showcases an embodiment of the apparatus that combines comfort, functionality, and style. It demonstrates the practical application of the sound detection system in a form factor that is familiar and wearable, facilitating the adoption of advanced audio processing capabilities into the daily lives of users.

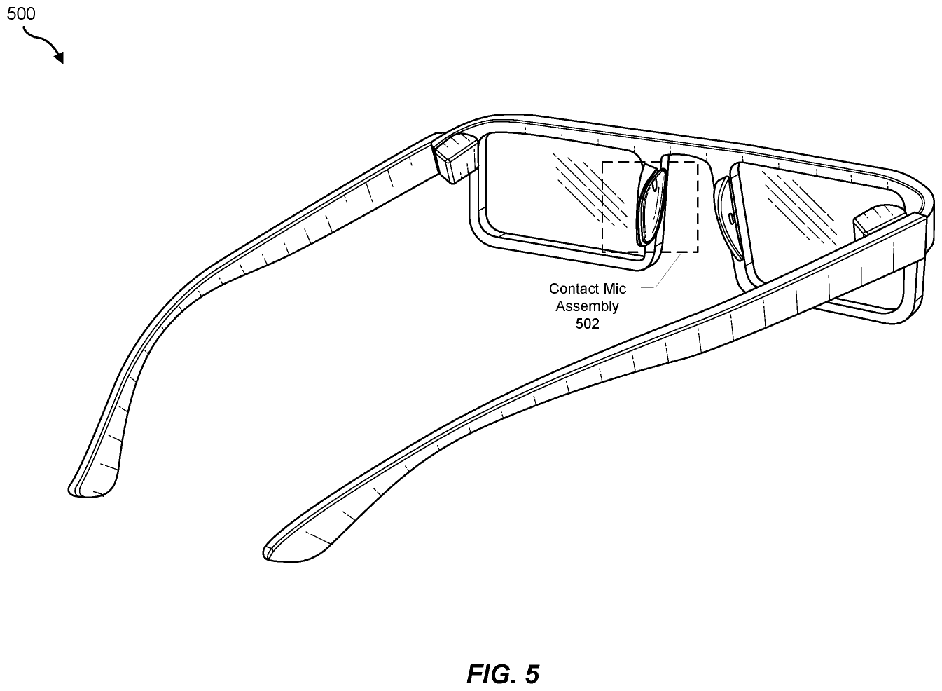

FIG. 5 presents a perspective view 500 that illustrates an embodiment where a contact microphone assembly is incorporated into the nose pad area of a pair of glasses. This representation focuses on the placement of the contact microphone assembly 502 within the nose pad, potentially enhancing the apparatus's ability to capture audio via bone conduction.

The contact microphone assembly 502 is depicted as being positioned to align with the user's nose, which may allow for the direct transmission of vibrations generated by the user and conducted by the tissues of the user's nose into the device. The integration is such that the contact microphone assembly 502 could be contained within or as part of the nose pad structure, suggesting a design that could maintain the conventional aesthetics of eyewear while incorporating contact-based sound-detection functionality.

In this example, the contact microphone assembly 502 is centrally located in what appears to be a key contact point of the glasses frame, a placement that may be beneficial for capturing sound vibrations from the user. While the intricate details of the contact microphone assembly itself are not visible in this view, its presence within the nose pad is indicative of a design aimed at capturing vibrations efficiently.

The glasses frame, part of view 500, extends beyond the contact microphone assembly 502, suggesting a structure that might support and protect the embedded technology. The design of the frame could offer the dual advantage of housing the contact microphone assembly 502 without altering the familiar form of the glasses.

FIG. 5 thus illustrates a configuration that might allow the integration of sound-detection capabilities in a non-intrusive manner. The depiction serves to convey one of the potential methods by which the disclosed technology can be applied to wearable devices, considering both functional requirements and user comfort.

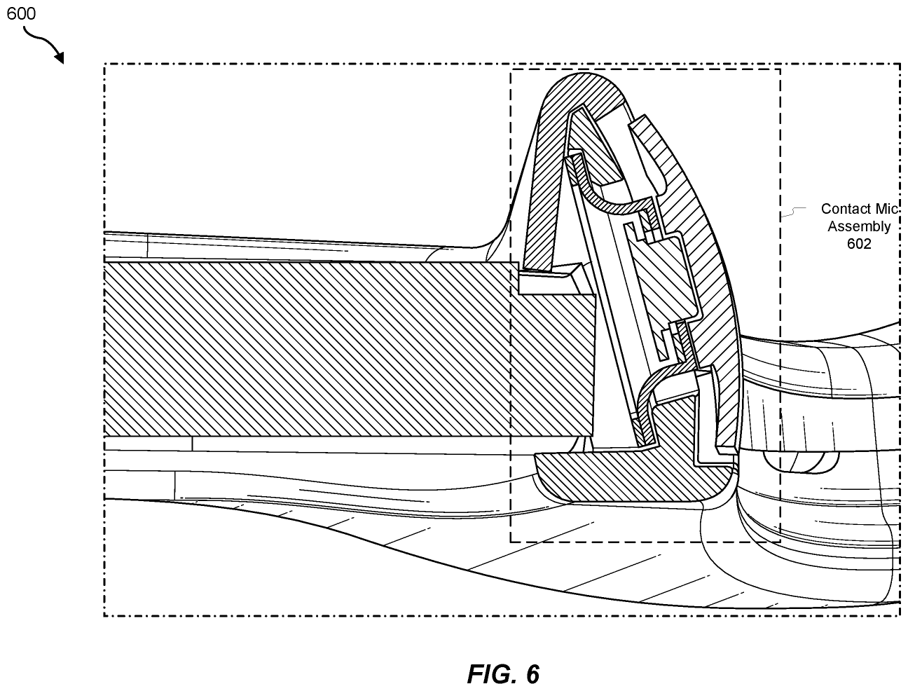

FIG. 6 provides a cross-sectional view 600 that illustrates a potential integration of a contact microphone assembly within the framework of a wearable device, which in this case is exemplified as a pair of smart glasses. The figure is intended to complement the information provided above in relation to FIG. 3, FIG. 4, and FIG. 5, offering a detailed perspective on the positioning and incorporation of a contact microphone assembly 602 within the glasses' structure.

The contact microphone assembly 602 is positioned in a manner that suggests it is nested within the interior of the glasses frame, in proximity to where the nose pad would typically be located. This strategic placement may allow for the effective capture of sound vibrations from the user's nose through direct contact, utilizing bone conduction as a means to transmit audio signals to the microphone assembly. Contact microphone assembly 602 is designed to fit within the contours of the glasses frame, which may provide a snug and secure housing for the microphone, optimizing both the aesthetic integration and the functional performance of the sound detection system.

FIG. 4, FIG. 5, and FIG. 6 aim to visually convey some of many possible design approaches for integrating advanced sound detection technology into a wearable device. They showcase how a contact microphone assembly as described herein could be seamlessly incorporated into a pair of smart glasses, enabling efficient sound capture without compromising on design or comfort expected of everyday eyewear.

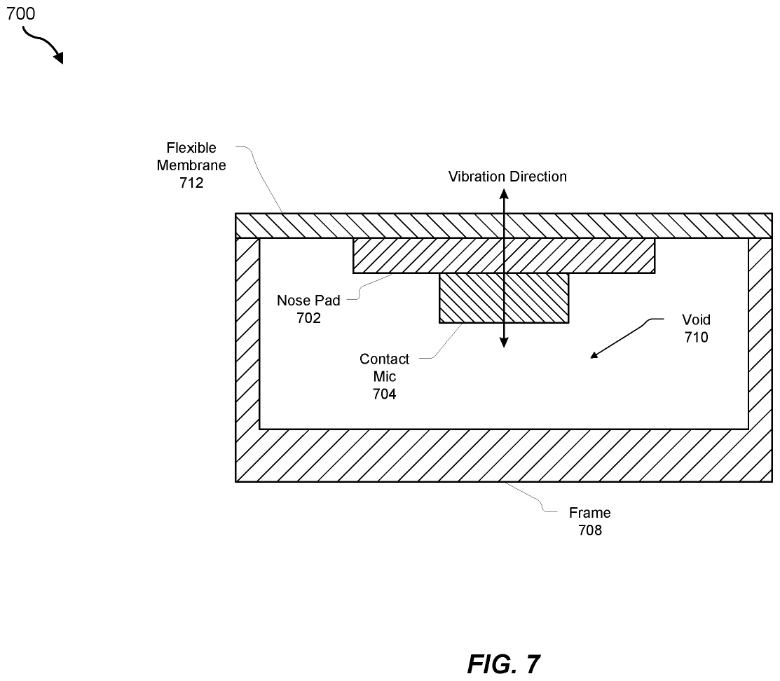

The principles described herein are amenable to a variety of variations and additional and/or alternative embodiments. By way of illustration, FIG. 7 illustrates a simplified cross-sectional view 700 of an additional example showcasing an additional contact microphone assembly designed for audio capture through bone conduction. While drawing parallels to FIG. 1 and FIG. 2, FIG. 7 introduces additional or alternative components that can be utilized to implement the principles described herein within the structure of a wearable device such as smart glasses.

As with examples described above, the example shown in FIG. 7 incorporates a nose pad 702, which may be contoured to comfortably interface with a user's nose. The rigid nose pad 702 is purposed to make, in this example, indirect contact with the skin (e.g., via flexible membrane 712, described in greater detail below), which may enable transmission of vibrations resulting from the user's speech and/or other vocalizations to the contact microphone assembly.

Located beneath the nose pad 702 is a contact microphone 704, potentially placed to optimally receive vibrations transmitted through nose pad. The contact microphone 704 may be configured to convert these mechanical vibrations into electrical signals, enabling the capture of audio data through bone conduction.

The glasses frame 708, as part of the cross-section view 700, is depicted to provide a structure within which the nose pad 702 and contact microphone 704 are integrated. The frame 708 may be designed to support the overall assembly, contributing to the device's structural stability and comfort when worn by the user.

Central to this embodiment is the inclusion of a flexible membrane 712, which may serve the function of previously described components such as soft springs 212 and/or soft springs 312 in other embodiments. The flexible membrane 712 could afford the assembly a degree of resilience and movement, denoted by the “Vibration Direction” arrow, allowing the nose pad 702 to respond adaptively to the user's movements and facial expressions, while also transmitting vibrations to nose pad 702 and/or contact microphone 704.

A void 710 is defined by the glasses frame 708 and may be dimensioned to accommodate the flexible membrane 712 and the associated contact microphone assembly. This void 710 provides the necessary space for the components to move and function effectively, potentially also contributing to the ease of assembly and maintenance of the device. In some examples, flexible membrane 712 may deform when the wearable device is donned by a user, causing portions of flexible membrane 712, nose pad 702, and/or contact microphone 704 to move within void 710. This may facilitate user comfort and/or maintain contact between the user's body and the flexible membrane 712, thereby enhancing the transmission of vibrations from the user to the contact microphone 704.

FIG. 7 thus sets forth an illustrative example of how various components, including a flexible membrane 712, might be configured within the framework of smart glasses to enhance audio capture capabilities. This embodiment may represent one of several ways the disclosed technology can be applied, highlighting the adaptability of the design to different configurations and the potential for a modular approach to component integration.

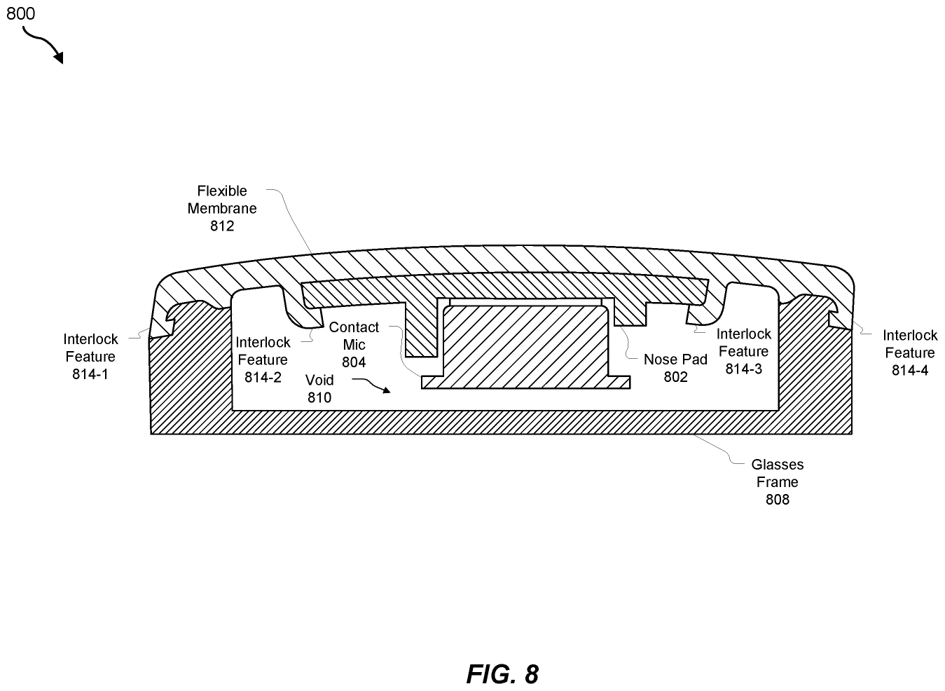

FIG. 8 presents a detailed cross-sectional view 800 of an example of an apparatus for detecting sound through a nose pad integrated into a pair of glasses. This example includes a flexible membrane and is consistent with the inventive concepts described previously, with a particular focus on optimizing audio capture via bone conduction.

The example illustrated in FIG. 8 features a rigid nose pad 802, which is designed to rest against the user's nose. The nose pad 802 may be configured to have a surface or shape that enhances comfort and ensures a secure fit to facilitate the efficient transmission of sound vibrations through bone conduction to the contact microphone.

Beneath the rigid nose pad 802 lies the contact microphone 804, which is positioned to receive vibrations emanating from the user's nose. The contact microphone 804 might be equipped with a transducer capable of converting these mechanical vibrations into corresponding electrical signals, thereby capturing audio data that can be processed to reproduce sound with clarity.

A flexible membrane 812 is depicted in this example, potentially serving multiple functions. It may provide the necessary elasticity to allow the nose pad 802 to move in response to the vibrations, indicated by the arrows denoting the “Vibration Direction.” This flexibility could also play a role in enhancing the user's comfort by distributing the pressure of the glasses against the nose. Moreover, flexible membrane 812 may transmit vibrations from the user's nose to the nose pad 802, with the vibrations continuing from thence to the contact microphone 804.

As in other examples described herein, the void 810 within the glasses frame 808 is configured to accommodate the flexible membrane 812, the nose pad 802, and the contact microphone 804. The spatial arrangement within the void 810 enables proper function of the microphone assembly, allowing for both the necessary movement of the nose pad 802 and the secure placement of the contact microphone 804. In some examples, flexible membrane 812 may deform when the glasses are donned by a user, causing portions of flexible membrane 812, nose pad 802, and/or contact microphone 804 to move within void 810. This may facilitate user comfort and/or maintain contact with the flexible membrane 812, thereby enhancing the transmission of vibrations from the user to the contact microphone 804.

As further shown in FIG. 8, there may be one or more interlock features 814 (e.g., interlock feature 814-1, interlock feature 814-2, interlock feature 814-3, and interlock feature 814-4) included as part of glasses frame 808, flexible membrane 812, and/or nose pad 802 that may facilitate and/or improve bonding between flexible membrane 812 and the rigid nose pad 802. These features may also prevent delamination that may happen during manufacturing. Such potential delamination can cause audio distortion, reliability issues, integration issues, and so forth.

The glasses frame 808 encases the components, lending structural integrity to the assembly while potentially conforming to the aesthetic norms of eyewear design. The frame 808 may be composed of materials that balance rigidity with flexibility to support the integrated components effectively.

FIG. 8 aims to detail an example that reflects one of several ways to incorporate bone conduction technology into a wearable device. It emphasizes the integration of a flexible membrane with traditional components of a pair of glasses to create a system that may capture audio efficiently while maintaining the conventional look and feel of eyewear.

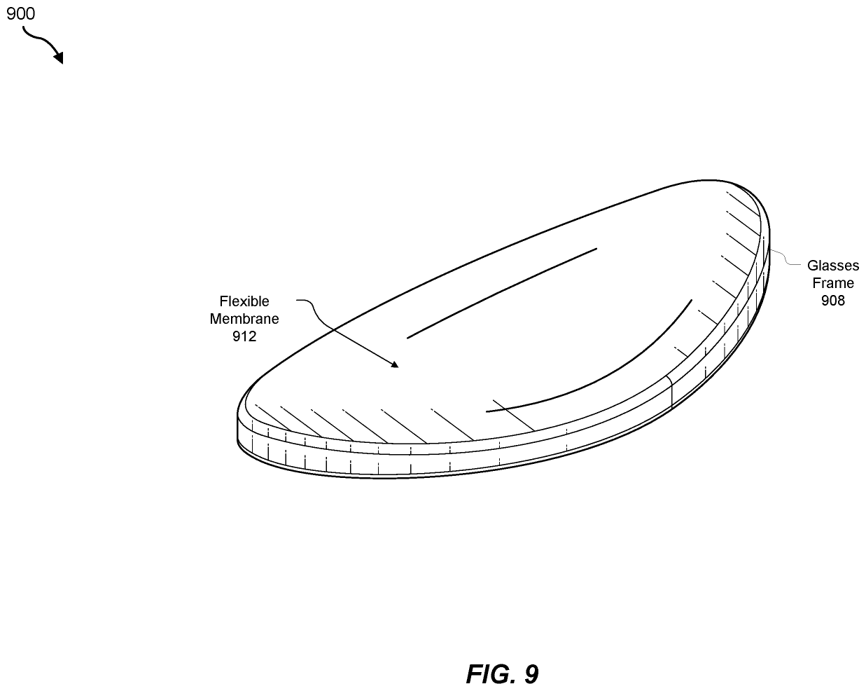

FIG. 9 presents a close-up perspective view 900, which emphasizes a specific aspect of the integration of a contact microphone assembly within the structure of a wearable device, such as a pair of glasses. The illustration focuses on a flexible membrane, labeled 912, which is a component of the glasses frame, indicated as 908. In this depiction, the flexible membrane 912 serves as an interface between the user and the contact microphone assembly (not visible in this view). The flexible membrane 912 may be designed to conform to the shape of the glasses, blending seamlessly with the overall aesthetic of the device.

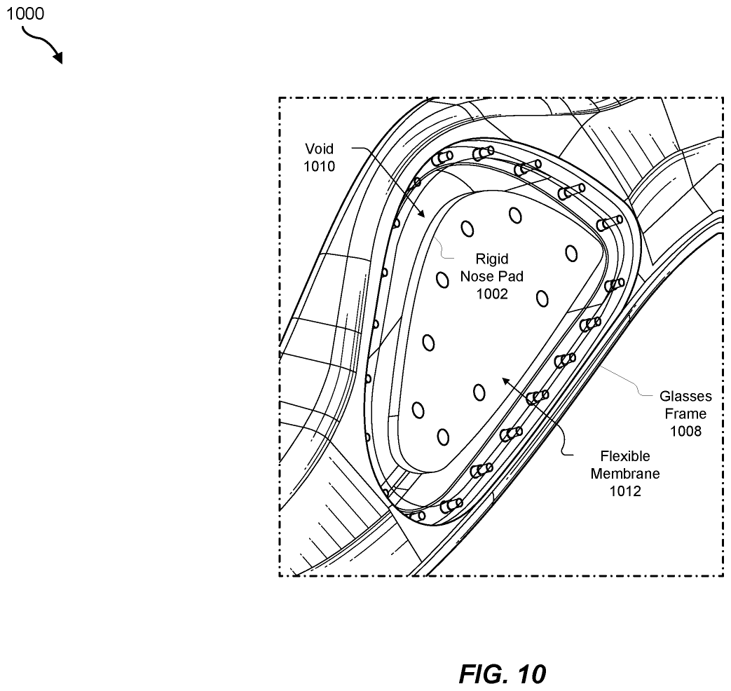

FIG. 10 shows an alternative perspective view 1000 of a contact microphone assembly integrated within a nose pad of a pair of smart glasses. In this view, a flexible membrane 1012 is shown in a transparent view, allowing a view of a rigid nose pad 1002 and a void 1010 through flexible membrane 1012. Although not shown in FIG. 10, a contact microphone may be communicatively coupled to an opposing side of rigid nose pad 1002. As shown, the contact microphone assembly is embedded within glasses frame 1008, with flexible membrane 1012 smoothly integrating the surface of contact microphone assembly into glasses frame 1008.

FIG. 11 is a block diagram of an example system 1100 for detecting sound via a wearable device. As illustrated in this figure, example system 1100 may include one or more modules 1102 for performing one or more tasks. As will be explained in greater detail below, modules 1102 may include a receiving module 1104 that may receive, via a vibration sensor included in a nose pad included in a pair of glasses, an electrical signal representative of vibrations received by the vibration sensor. Additionally, modules 1102 may also include a converting module 1106 that may convert the electrical signal into digital audio data. In some examples, modules 1102 may also include an adjusting module 1108 that may adjust the audio data to enhance an aspect of human speech represented in the audio data.

As further illustrated in FIG. 11, example system 1100 may also include one or more memory devices, such as memory 1120. Memory 1120 generally represents any type or form of volatile or non-volatile storage device or medium capable of storing data and/or computer-readable instructions. In one example, memory 1120 may store, load, and/or maintain one or more of modules 1102. Examples of memory 1120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 11, example system 1100 may also include one or more physical processors, such as physical processor 1130. Physical processor 1130 generally represents any type or form of hardware-implemented processing unit capable of interpreting and/or executing computer-readable instructions. In one example, physical processor 1130 may access and/or modify one or more of modules 1102 stored in memory 1120. Additionally or alternatively, physical processor 1130 may execute one or more of modules 1102 to facilitate providing a community-based dating service for a social networking system. Examples of physical processor 1130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in FIG. 11, example system 1100 may also include one or more stores of data, such as data store 1140. Data store 1140 may represent portions of a single data store or computing device or a plurality of data stores or computing devices. In some embodiments, data store 1140 may be a logical container for data and may be implemented in various forms (e.g., a database, a file, file system, a data structure, etc.). Examples of data store 1140 may include, without limitation, one or more files, file systems, data stores, databases, and/or database management systems such as an operational data store (ODS), a relational database, a NoSQL database, a NewSQL database, and/or any other suitable organized collection of data.

Additionally, example system 1100 may also include a wearable device 1150 that may include a vibration sensor 1152. In some examples, the wearable device 1150 may include a pair of glasses and/or smart glasses. In some examples, the vibration sensor 1152 may include a contact microphone. In some examples, a wearable device may include any electronic technology or device that can be worn on the body, either as an accessory or as part of material used in clothing. Wearable devices can perform many of the same computing tasks as mobile phones and laptop computers.

In some examples, a vibration sensor may include a device that measures the amount and/or frequency of vibration in a given system, machinery, piece of equipment, and so forth. Vibration sensors in wearable technology often use accelerometers or gyroscopes to detect movement, orientation, and inclination. In some examples, a vibration sensor may include a contact microphone. A contact microphone, also known as a pickup or piezo microphone, may include a type of microphone that picks up audio by being in direct contact with a vibrating surface. It may convert vibrations into electrical signals, differentiating from other microphones that typically pick up sound through the air. In some wearable devices, as described herein, a contact microphone can be used to detect voice through bone conduction, where the vibrations of the user's speech are picked up from a solid surface such as the bone of the user's head or nose.

Example system 1100 in FIG. 11 may be implemented in a variety of ways. For example, all or a portion of example system 1100 may represent portions of an example system 1200 (“system 1200”) in FIG. 12. As shown in FIG. 12, system 1200 may include a control device 1202 in communication with a wearable device 1150 via a connection 1204. In at least one example, control device 1202 may be programmed with one or more of modules 1102.

In at least one embodiment, one or more modules 1102 from FIG. 11 may, when executed by control device 1202, enable control device 1202 to perform one or more operations to detect sound via a wearable device. For example, as will be described in greater detail below, receiving module 1104 may cause control device 1202 to receive, via a vibration sensor included in a nose pad included in a pair of glasses (e.g., vibration sensor 104, contact microphone 204, contact mic 304, contact mic 704, contact mic 804, vibration sensor 1152, etc.) an electrical signal (e.g., electrical signal 1206) representative of vibrations received by the vibration sensor. Additionally, converting module 1106 may cause control device 1202 to convert the electrical signal into digital audio data (e.g., audio data 1208). Furthermore, in some examples, one or more of modules 1102 (e.g., adjusting module 1108) may cause control device 1202 to adjust the audio data to enhance an aspect of human speech represented in the audio data.

Control device 1202 generally represents any type or form of computing device capable of reading and/or executing computer-executable instructions. In at least one embodiment, control device 1202 may be integrated within wearable device 1150. Examples of control device 1202 include, without limitation, wearable devices (e.g., smart watches, smart glasses, etc.), gaming consoles, combinations of one or more of the same, or any other suitable mobile computing device.

Connection 1204 generally represents any medium or architecture capable of facilitating communication and/or data transfer between control device 1202 and wearable device 1150. Examples of connection 1204 may include, without limitation, one or more internal connections, one or more network connections, one or more universal serial bus (USB) connections, and the like. Connection 1204 may facilitate communication or data transfer using wireless or wired connections. In one embodiment, connection 1204 may facilitate communication between control device 1202 and wearable device 1150. Moreover, as described above, control device 1202 and/or connection 1204 may be incorporated within wearable device 1150.

In at least one example, control device 1202 may be a computing device programmed with one or more of modules 1102. All or a portion of the functionality of modules 1102 may be performed by control device 1202 and/or any other suitable computing system. As will be described in greater detail below, one or more of modules 1102 from FIG. 11 may, when executed by at least one processor of control device 1202, may enable control device 1202 to detect sound via a wearable device.

Many other devices or subsystems may be connected to example system 1100 in FIG. 11 and/or example system 1200 in FIG. 12. Conversely, all of the components and devices illustrated in FIGS. 11 and 12 need not be present to practice the embodiments described and/or illustrated herein. The devices and subsystems referenced above may also be interconnected in different ways from those shown in FIG. 12. Example systems 1100 and 1200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 13 is a flow diagram of an example computer-implemented method 1300 for detecting sound via a wearable device. The steps shown in FIG. 13 may be performed by any suitable computer-executable code and/or computing system, including example system 1100 in FIG. 11, example system 1200 in FIG. 12, and/or variations or combinations of one or more of the same. In one example, each of the steps shown in FIG. 13 may represent an algorithm whose structure includes and/or is represented by multiple sub-steps, examples of which will be provided in greater detail below.

The method depicted in FIG. 13 aligns with the operations of the example systems shown in FIGS. 11 and 12. The process initiates at step 1310 with the reception of an electrical signal through a vibration sensor, which may be incorporated into a nose pad that is part of a wearable device, such as a pair of glasses. This electrical signal (e.g., electrical signal 1206) is representative of vibrations, and in some examples, these vibrations are sound detected by a contact microphone included as the vibration sensor.

Continuing to step 1320, the method involves the transformation of the received electrical signal into audio data (e.g., audio data 1208). This conversion is facilitated by a converting module situated within a control device. This control device is in communication with the wearable device via a connection, as illustrated in FIG. 12.

In some embodiments, the method includes an additional step 1330, which involves adjusting the audio data to enhance a characteristic of human speech within it. This adjustment might involve enhancing the clarity of speech, particularly focusing on speech produced by a user wearing the glasses. The task of adjusting the audio may be executed by an adjusting module housed within the control device, potentially employing specialized algorithms to identify and clarify speech patterns. For example, the control device may employ one or more equalization algorithms to correct and/or enhance bone conducted speech to sound more natural.

Additionally or alternatively, the one or more modules (e.g., modules 1102) may employ one or more algorithms (e.g., artificial intelligence, machine learning, and/or other algorithms) to further reduce noise in and/or correct received bone-conduced speech to further improve (e.g., increase a SNR of) an audio signal. In some examples, the one or more modules may adjust the audio data to enhance clarity of and/or isolate human speech produced by the user as opposed to human speech produced by another person (e.g., another person speaking in close proximity to the user).

Overall, the apparatuses, systems, and methods described herein aim to innovatively capture and process audio using bone conduction via the nose pad of glasses and to enhance the resulting audio for clearer human speech. The description, in conjunction with FIGS. 11, 12, and 13, provides a comprehensive view of some ways the disclosed apparatuses and systems can be practically applied, incorporating both hardware and software components of the described apparatuses and systems to execute the method steps effectively.

As discussed throughout this disclosure, including the accompanying drawings, the disclosed apparatuses, systems, and methods may provide many advantages over conventional options for audio pickup by wearable devices. For example, the custom acoustic sensor disclosed herein, in addition to being small in size, is of higher frequency bandwidth, provides a higher SNR, and exhibits lower noise than other conventional options. Additionally, a movable nose pad with rigid diaphragm and soft suspension surround as described herein may provide good contact to the nose while providing and/or enhancing user comfort. Furthermore, the movable nose pad may have a good frequency response when receiving the bone-conducted signals from the nose. Moreover, the methods of audio enhancement described herein may increase audio quality by correcting bone conducted speech signal to sound more natural, reducing noise, and/or improving SNR.

Embodiments of the disclosure may offer an improvement in voice pickup for Voice Over Internet Protocol (VOIP) applications. This advancement is particularly notable in challenging acoustic environments where noise conditions can significantly degrade the quality of voice communication. Users can expect a marked increase in the raw microphone Signal-to-Noise Ratio (SNR) by approximately 10 dB, which facilitates clearer voice transmission during calls, video recording, and live streaming activities, even in the presence of environmental noises such as strong winds or conversations from adjacent individuals.

For voice recognition tasks, embodiments of the instant disclosure may enhance Automatic Speech Recognition (ASR) accuracy. This is especially beneficial when the user is interacting with virtual assistants and other AI-driven applications where ambient noise or interruptions by other speakers may otherwise disrupt recognition accuracy. By improving the clarity of voice pickup through the contact microphone, the system ensures that voice commands are captured more distinctly, leading to a more responsive and reliable user experience.

Additionally, embodiments of the instant disclosure may unlock and/or enable an AI whisper mode, which may enhance user privacy. Traditional acoustic microphones struggle to pick up whispered speech in the presence of background noise. However, a contact microphone as incorporated into some embodiments described herein, can effectively capture whispered speech, enabling users to interact with their devices discreetly without sacrificing privacy.

By way of illustration, FIG. 14 includes a chart 1400 that shows a difference between performance of a contact microphone as implemented in the apparatuses and systems versus a conventional acoustic microphone in a windy environment. Furthermore, FIG. 15 shows a chart 1500 that shows a difference in speech enhancement of a contact microphone as implemented in the apparatuses and systems disclosed herein versus conventional acoustic microphones.

Furthermore, some embodiments may contribute to power efficiency with an optimized wake-word detection process, which may translate to increased idle time of the device. This may result in energy savings and longer battery life, making the device more sustainable and user-friendly in daily operations.

These benefits may signify a leap forward in wearable device functionality, enriching user interaction with voice-controlled systems and extending the usability and convenience of smart glasses. These improvements align with the objectives of providing users with a seamless and enhanced auditory experience, whether in personal communication, interacting with AI assistants, or engaging with multimedia content. The adaptability of embodiments of the instant disclosure to various noise environments and their capability to understand whispered commands showcase their versatility and advanced technological design.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality-systems may be designed to work without near-eye displays (NEDs). Other artificial-reality systems may include an NED that also provides visibility into the real world (such as, e.g., augmented-reality system 1600 in FIG. 16) or that visually immerses a user in an artificial reality (such as, e.g., virtual-reality system 1700 in FIG. 17). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 16, augmented-reality system 1600 may include an eyewear device 1602 with a frame 1610 configured to hold a left display device 1615(A) and a right display device 1615(B) in front of a user's eyes. Display devices 1615(A) and 1615(B) may act together or independently to present an image or series of images to a user. While augmented-reality system 1600 includes two displays, embodiments of this disclosure may be implemented in augmented-reality systems with a single NED or more than two NEDs.

In some embodiments, augmented-reality system 1600 may include one or more sensors, such as sensor 1640. Sensor 1640 may generate measurement signals in response to motion of augmented-reality system 1600 and may be located on substantially any portion of frame 1610. Sensor 1640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1600 may or may not include sensor 1640 or may include more than one sensor. In embodiments in which sensor 1640 includes an IMU, the IMU may generate calibration data based on measurement signals from sensor 1640. Examples of sensor 1640 may include, without limitation, accelerometers, gyroscopes, magnetometers, other suitable types of sensors that detect motion, sensors used for error correction of the IMU, or some combination thereof.

In some examples, augmented-reality system 1600 may also include a microphone array with a plurality of acoustic transducers 1620(A)-1620(J), referred to collectively as acoustic transducers 1620. Acoustic transducers 1620 may represent transducers that detect air pressure variations induced by sound waves. Each acoustic transducer 1620 may be configured to detect sound and convert the detected sound into an electronic format (e.g., an analog or digital format). The microphone array in FIG. 16 may include, for example, ten acoustic transducers: 1620(A) and 1620(B), which may be designed to be placed inside a corresponding ear of the user, acoustic transducers 1620(C), 1620(D), 1620(E), 1620(F), 1620(G), and 1620(H), which may be positioned at various locations on frame 1610, and/or acoustic transducers 1620(I) and 1620(J), which may be positioned on a corresponding neckband 1605.

In some embodiments, one or more of acoustic transducers 1620(A)-(J) may be used as output transducers (e.g., speakers). For example, acoustic transducers 1620(A) and/or 1620(B) may be earbuds or any other suitable type of headphone or speaker.

The configuration of acoustic transducers 1620 of the microphone array may vary. While augmented-reality system 1600 is shown in FIG. 16 as having ten acoustic transducers 1620, the number of acoustic transducers 1620 may be greater or less than ten. In some embodiments, using higher numbers of acoustic transducers 1620 may increase the amount of audio information collected and/or the sensitivity and accuracy of the audio information. In contrast, using a lower number of acoustic transducers 1620 may decrease the computing power required by an associated controller 1650 to process the collected audio information. In addition, the position of each acoustic transducer 1620 of the microphone array may vary. For example, the position of an acoustic transducer 1620 may include a defined position on the user, a defined coordinate on frame 1610, an orientation associated with each acoustic transducer 1620, or some combination thereof.

Acoustic transducers 1620(A) and 1620(B) may be positioned on different parts of the user's ear, such as behind the pinna, behind the tragus, and/or within the auricle or fossa. Or, there may be additional acoustic transducers 1620 on or surrounding the ear in addition to acoustic transducers 1620 inside the ear canal. Having an acoustic transducer 1620 positioned next to an ear canal of a user may enable the microphone array to collect information on how sounds arrive at the ear canal. By positioning at least two of acoustic transducers 1620 on either side of a user's head (e.g., as binaural microphones), augmented-reality system 1600 may simulate binaural hearing and capture a 3D stereo sound field around about a user's head. In some embodiments, acoustic transducers 1620(A) and 1620(B) may be connected to augmented-reality system 1600 via a wired connection 1630, and in other embodiments acoustic transducers 1620(A) and 1620(B) may be connected to augmented-reality system 1600 via a wireless connection (e.g., a BLUETOOTH connection). In still other embodiments, acoustic transducers 1620(A) and 1620(B) may not be used at all in conjunction with augmented-reality system 1600.

Acoustic transducers 1620 on frame 1610 may be positioned in a variety of different ways, including along the length of the temples, across the bridge, above or below display devices 1615(A) and 1615(B), or some combination thereof. Acoustic transducers 1620 may also be oriented such that the microphone array is able to detect sounds in a wide range of directions surrounding the user wearing the augmented-reality system 1600. In some embodiments, an optimization process may be performed during manufacturing of augmented-reality system 1600 to determine relative positioning of each acoustic transducer 1620 in the microphone array.

In some examples, augmented-reality system 1600 may include or be connected to an external device (e.g., a paired device), such as neckband 1605. Neckband 1605 generally represents any type or form of paired device. Thus, the following discussion of neckband 1605 may also apply to various other paired devices, such as charging cases, smart watches, smart phones, wrist bands, other wearable devices, hand-held controllers, tablet computers, laptop computers, other external compute devices, etc.

As shown, neckband 1605 may be coupled to eyewear device 1602 via one or more connectors. The connectors may be wired or wireless and may include electrical and/or non-electrical (e.g., structural) components. In some cases, eyewear device 1602 and neckband 1605 may operate independently without any wired or wireless connection between them. While FIG. 16 illustrates the components of eyewear device 1602 and neckband 1605 in example locations on eyewear device 1602 and neckband 1605, the components may be located elsewhere and/or distributed differently on eyewear device 1602 and/or neckband 1605. In some embodiments, the components of eyewear device 1602 and neckband 1605 may be located on one or more additional peripheral devices paired with eyewear device 1602, neckband 1605, or some combination thereof.

Pairing external devices, such as neckband 1605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1600 may be provided by a paired device or shared between a paired device and an eyewear device, thus reducing the weight, heat profile, and form factor of the eyewear device overall while still retaining desired functionality. For example, neckband 1605 may allow components that would otherwise be included on an eyewear device to be included in neckband 1605 since users may tolerate a heavier weight load on their shoulders than they would tolerate on their heads. Neckband 1605 may also have a larger surface area over which to diffuse and disperse heat to the ambient environment. Thus, neckband 1605 may allow for greater battery and computation capacity than might otherwise have been possible on a stand-alone eyewear device. Since weight carried in neckband 1605 may be less invasive to a user than weight carried in eyewear device 1602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1605 may be communicatively coupled with eyewear device 1602 and/or to other devices. These other devices may provide certain functions (e.g., tracking, localizing, depth mapping, processing, storage, etc.) to augmented-reality system 1600. In the embodiment of FIG. 16, neckband 1605 may include two acoustic transducers (e.g., 1620(I) and 1620(J)) that are part of the microphone array (or potentially form their own microphone subarray). Neckband 1605 may also include a controller 1625 and a power source 1635.

Acoustic transducers 1620(I) and 1620(J) of neckband 1605 may be configured to detect sound and convert the detected sound into an electronic format (analog or digital). In the embodiment of FIG. 16, acoustic transducers 1620(I) and 1620(J) may be positioned on neckband 1605, thereby increasing the distance between the neckband acoustic transducers 1620(I) and 1620(J) and other acoustic transducers 1620 positioned on eyewear device 1602. In some cases, increasing the distance between acoustic transducers 1620 of the microphone array may improve the accuracy of beamforming performed via the microphone array. For example, if a sound is detected by acoustic transducers 1620(C) and 1620(D) and the distance between acoustic transducers 1620(C) and 1620(D) is greater than, e.g., the distance between acoustic transducers 1620(D) and 1620(E), the determined source location of the detected sound may be more accurate than if the sound had been detected by acoustic transducers 1620(D) and 1620(E).

Controller 1625 of neckband 1605 may process information generated by the sensors on neckband 1605 and/or augmented-reality system 1600. For example, controller 1625 may process information from the microphone array that describes sounds detected by the microphone array. For each detected sound, controller 1625 may perform a direction-of-arrival (DOA) estimation to estimate a direction from which the detected sound arrived at the microphone array. As the microphone array detects sounds, controller 1625 may populate an audio data set with the information. In embodiments in which augmented-reality system 1600 includes an inertial measurement unit, controller 1625 may compute all inertial and spatial calculations from the IMU located on eyewear device 1602. A connector may convey information between augmented-reality system 1600 and neckband 1605 and between augmented-reality system 1600 and controller 1625. The information may be in the form of optical data, electrical data, wireless data, or any other transmittable data form. Moving the processing of information generated by augmented-reality system 1600 to neckband 1605 may reduce weight and heat in eyewear device 1602, making it more comfortable to the user.

Power source 1635 in neckband 1605 may provide power to eyewear device 1602 and/or to neckband 1605. Power source 1635 may include, without limitation, lithium-ion batteries, lithium-polymer batteries, primary lithium batteries, alkaline batteries, or any other form of power storage. In some cases, power source 1635 may be a wired power source. Including power source 1635 on neckband 1605 instead of on eyewear device 1602 may help better distribute the weight and heat generated by power source 1635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1700 in FIG. 17, that mostly or completely covers a user's field of view. Virtual-reality system 1700 may include a front rigid body 1702 and a band 1704 shaped to fit around a user's head. Virtual-reality system 1700 may also include output audio transducers 1706(A) and 1706(B). Furthermore, while not shown in FIG. 17, front rigid body 1702 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1600 and/or virtual-reality system 1700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1600 and/or virtual-reality system 1700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1600 and/or virtual-reality system 1700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The following example embodiments are also included in this disclosure:

Example 1: An apparatus comprising: a nose pad included in a pair of glasses that, when the glasses are worn by a user, physically contacts a portion of a nose of the user at a contact point; and a vibration sensor, included in the nose pad and configured to receive, via the contact point, vibrations produced by the user.

Example 2: The apparatus of example 1, wherein: the vibration sensor comprises a contact microphone; and the received vibrations comprise sound generated by the user.

Example 3: The apparatus of example 2, wherein the sound generated by the user comprises human speech generated by the user.

Example 4: The apparatus of any of examples 1-3, wherein the vibration sensor is communicatively coupled to a control device configured to convert the received vibrations into audio data.

Example 5: The apparatus of any of examples 1-4, wherein the nose pad is positioned within a void defined by a frame of the glasses.

Example 6: The apparatus of example 5, wherein the void is dimensioned to: accommodate the nose pad; and allow the nose pad to move within the void in response to the received vibrations.

Example 7: The apparatus of any of examples 5-6, wherein the nose pad further comprises a spring that forms at least part of a physical connection between the nose pad and the frame.

Example 8: The apparatus of example 7, wherein the spring suspends the nose pad within the void such that the spring, nose pad, and frame further define a movement volume within the void.

Example 9: The apparatus of example 8, wherein the nose pad moves within the movement volume in reaction to the received vibrations.

Example 10: The apparatus of any of examples 1-9, wherein the nose pad further comprises a rigid contact member that contacts the nose of the user when the glasses are worn by the user.

Example 11: The apparatus of example 10, wherein the vibration sensor receives the vibrations via the rigid contact member.

Example 12: The apparatus of example 11, wherein the vibration sensor is in physical contact with the rigid contact member.

Example 13: A system comprising: a pair of glasses comprising: a nose pad that, when the pair of glasses are worn by a user, contacts a portion of a nose of the user at a contact point; and a vibration sensor, included in the nose pad, configured to: receive vibrations produced by the user via the contact point; and convert the received vibrations into an electrical signal representative of the received vibrations; and a control device configured to: receive the electrical signal; and convert the electrical signal into digital audio data.

Example 14: The system of example 13, wherein the nose pad is positioned within a void defined by a frame of the glasses.

Example 15: The system of example 14, wherein the nose pad further comprises a spring that forms at least part of a physical connection between the nose pad and the frame.

Example 16: A method comprising; receiving, via a vibration sensor included in a nose pad included in a pair of glasses, an electrical signal representative of vibrations received by the vibration sensor; and converting the electrical signal into audio data.

Example 17: The method of example 16, wherein: the vibration sensor comprises a contact microphone; and the vibrations received by the vibration sensor comprise sound detected by the contact microphone.

Example 18: The method of any of examples 16-17, further comprising adjusting the audio data to enhance an aspect of human speech represented in the audio data.

Example 19: The method of example 18, wherein the human speech comprises human speech generated by a user who was wearing the pair of glasses when the vibration sensor received the received vibrations.

Example 20: The method of example 19, wherein adjusting the audio data to enhance an aspect of human speech comprises adjusting the audio data to enhance clarity of human speech produced by the user.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The present disclosure broadly describes various elements that, upon implementation, may incorporate additional or substitute components or features without departing from the scope of the present disclosure. For instance, a range of vibration sensors and contact microphones is contemplated, including but not limited to vibration sensor 104, contact microphone 204, contact microphone 304, contact microphone 704, and contact microphone 804. It is contemplated that in certain implementations, each sensor and/or microphone may feature an integrated stack up assembly designed to implement and/or support one or more operational capabilities of the sensor and/or microphone.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising:
a nose pad included in a pair of glasses that, when the glasses are worn by a user, physically contacts a portion of a nose of the user at a contact point; and
a vibration sensor, included in the nose pad and configured to receive, via the contact point, vibrations produced by the user.

2. The apparatus of claim 1, wherein:
the vibration sensor comprises a contact microphone; and
the received vibrations comprise sound generated by the user.

3. The apparatus of claim 2, wherein the sound generated by the user comprises human speech generated by the user.

4. The apparatus of claim 1, wherein the vibration sensor is communicatively coupled to a control device configured to convert the received vibrations into audio data.

5. The apparatus of claim 1, wherein the nose pad is positioned within a void defined by a frame of the glasses.

6. The apparatus of claim 5, wherein the void is dimensioned to:
accommodate the nose pad; and
allow the nose pad to move within the void in response to the received vibrations.

7. The apparatus of claim 5, wherein the nose pad further comprises a spring that forms at least part of a physical connection between the nose pad and the frame.

8. The apparatus of claim 7, wherein the spring suspends the nose pad within the void.

9. The apparatus of claim 8, wherein the nose pad moves within the void in reaction to the received vibrations.

10. The apparatus of claim 1, wherein the nose pad further comprises a rigid contact member that contacts the nose of the user when the glasses are worn by the user.

11. The apparatus of claim 10, wherein the vibration sensor receives the vibrations via the rigid contact member.

12. The apparatus of claim 11, wherein the vibration sensor is in physical contact with the rigid contact member.

13. A system comprising:
a pair of glasses comprising:
a nose pad that, when the pair of glasses are worn by a user, contacts a portion of a nose of the user at a contact point; and
a vibration sensor, included in the nose pad, configured to:
receive vibrations produced by the user via the contact point; and
convert the received vibrations into an electrical signal representative of the received vibrations; and
a control device configured to:
receive the electrical signal; and
convert the electrical signal into digital audio data.

14. The system of claim 13, wherein the nose pad is positioned within a void defined by a frame of the glasses.

15. The system of claim 14, wherein the nose pad further comprises a spring that forms at least part of a physical connection between the nose pad and the frame.

16. A method comprising:
receiving, via a vibration sensor included in a nose pad included in a pair of glasses, an electrical signal representative of vibrations received by the vibration sensor; and
converting the electrical signal into digital audio data.

17. The method of claim 16, wherein:
the vibration sensor comprises a contact microphone; and
the vibrations received by the vibration sensor comprise sound detected by the contact microphone.

18. The method of claim 16, further comprising adjusting the audio data to enhance an aspect of human speech represented in the audio data.

19. The method of claim 18, wherein the human speech comprises human speech generated by a user who was wearing the pair of glasses when the vibration sensor received the received vibrations.

20. The method of claim 19, wherein adjusting the audio data to enhance an aspect of human speech comprises adjusting the audio data to enhance clarity of human speech produced by the user.
